(19) United States
(12) Patent Application Publication
(10) Pub. No.: US 2006/0197048 A1
(43) Pub. Date: Sep. 7, 2006

(54) Stuffing seal

(76) Inventor: Vincenzo Varriale, Cassina De Pecchi (MI) (IT)

Correspondence Address: AKERMAN SENTERFITT, P.O. BOX 3188, WEST PALM BEACH, FL, 33402-3188, US

(21) Appl. No.: 10/543,114

(22) PCT Filed: Jan. 22, 2004
(86) PCT No.: PCT/EP04/00495

§ 371 Date: Jan. 12, 2006

(30) Foreign Application Priority Data
Jan. 22, 2003 (IT) TO2003A 000028

(51) Int. Cl. F16K 31/44

(52) U.S. Cl. 251/214

(57) ABSTRACT

The present invention relates to a stuffing comprising a case (3a) provided with an axial hole (3afor the passage of a stem (103) being mobile with respect to said case (3); a gasket or packing (5) arranged in a seat (3b) formed within said hole (3a) between said case and said stem; and a stuffing box (7) for compressing said packing (5) between said case (3) and said stem (103), wherein releasable means (11) are provided to perform an axial thrust on said stuffing box (7), so as to cause a compression of said packing (5) between said case and said stem.

### TECHNICAL FIELD

The present invention relates to a stuffing seal.

The stuffing seal according to the invention is particularly applied in the field of the valves for fluids and it can be advantageously used as auxiliary seal, which intervenes in case of breakage of a primary seal.

### BACKGROUND ART

Stuffing seals are largely used for realising a seal between a shaft or mobile stem and a fixed body: they generally comprise a fixed case provided with a hole passing through the opening of a shaft or stem, a gasket or packing arranged within said hole between the case and the shaft or stem and a stuffing box which, through various systems, is axially pressed against the packing, thus compressing it between said case and said shaft or stem.

Stuffing seals are widely diffused in the field of valves for fluids; moreover, they are often used as auxiliary seals in the valves equipped with confining systems of other type (e.g. bellow seals), in order to avoid massive leaks of fluid in case of breakage of said confining systems.

One of the main problems of stuffing seals is represented by the loss of efficiency of the packing seal on the stem with the passage of time, due to wear or dryness of the primer, which generally impregnates the packing material.

Seals are known, which remedy said problem by means of springs (helical or, preferably, cup-like) which keep the packing constantly under pressure, compensating the wear thereof. An example of these seals is described in U.S. Pat. No. 4,340,204.

This solution is disadvantageous because it constantly submits the packing to a strong pressure which stresses the friction wear.

Moreover, in the case wherein the stuffing seal is used as auxiliary seal, the above solution is disadvantageous, since the packing is kept under pressure also when the seal is already ensured by the primary confining systems provided under normal operating conditions. This speeds the packing wear and it is source of useless frictions on the valve stem.

### DISCLOSURE OF INVENTION

A first aim of the present invention is thus that of realising a stuffing seal which does not has the above drawbacks and which ensures an efficient seal with time.

A second aim of the present invention is that of realising a stuffing seal advantageously usable as auxiliary seal able to avoid massive leaks of fluid in case of breakage of the primary confining systems.

A third aim of the invention is that of realising a stuffing seal of simple and economic production.

These and other aims are attained by the stuffing seal as claimed in the appended claims.

Advantageously, according to the invention, since the means for compressing the packing are normally kept in a position wherein they do not perform any pressure on said packing and they are quickly released only in case of need, the seal efficiency is ensured for a long period being the wear of the packing during the ordinary seal operation avoided.

Moreover, in the case of applications of a valve for fluids to the stem, said quick releasing means for compressing the packing are automatically controlled by an actuator in response to a leak of fluid further to a breakage of the primary confining means. Advantageously, the stuffing seal according to the invention also comprises means which exploit the pressure of the fluid itself for causing a partial compression of the packing, thus ensuring that the seal of said packing on the stem is increased in case of seeping of the fluid along said stem.

In the bellow valves the packing is a an emergency seal system, which must be sized for the entire operating life of the primary seal, unless maintenance interventions are carried out during operation, meeting the costs of it.

In case of a packing starting to operate when called for it because of a fault of the primary seal, it will be highly sure the finding of an efficient component, a saving on the sizes of the packing, a warning when starting to operate due to breakage of the primary seal, a lower length of the stem and sizing of the same, a reduced size and weight of the valve, a lower torque and subsequently a saving on the cost of the actuator, with a reduction of the operating costs.

Further characteristics and advantages of the present invention will be more apparent from the following description of some preferred embodiments, given by way of non-limiting example and shown in the attached drawings, wherein:

### BRIEF DESCRIPTION OF DRAWINGS

FIG. 1 is a partial section view of a valve for fluids provided with a stuffing seal according to the invention;

FIG. 2 is a section view of a detail of the valve of FIG. 1, relative to the stuffing seal according to the invention, with the packing being not compressed;

FIG. 3 is a section view of a detail of the valve of FIG. 1, relative to the stuffing seal according to the invention, with the packing being compressed;

FIG. 4a is a section view of the porous ring;

FIG. 4b is a section view of the porous ring according to a varying embodiment;

FIG. 5 is a section view of a detail of the valve of FIG. 1 with the packing being not compressed, in a varying embodiment of the invention.

### MODES FOR CARRYING OUT THE INVENTION

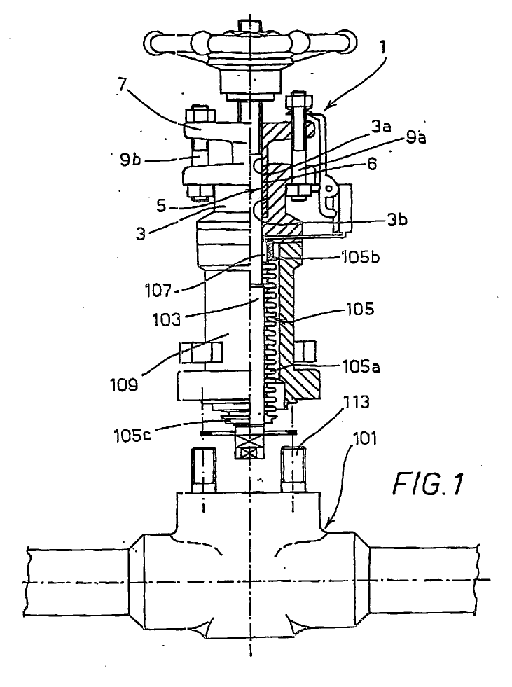

With reference to FIG. 1 a valve for fluids 101 is shown, which comprises a stuffing seal 1 according to a first embodiment of the invention.

Valve 101 is a valve of the type employed for intercepting special fluids requiring particular care for avoiding fluid leaks outside. These fluids are for example damaging, dangerous or expensive fluids.

To this purpose, valve 101 comprises a primary seal, the bellow seal 105 and a secondary seal, the stuffing seal 1.

The bellow seal 105 surrounds part of the stem 103 of valve 101. Said bellow seal 105 comprises a cylindrical body 105a, preferably multilayer, having a wavy profile. Said cylindrical body 105a is housed within a casing 109 fixed to the pivots 113 of valve 101 and it is therewith united by means of a ring 105b. At the opposite end with respect to the ring 105a, the body 105a is fixed, e.g. by welding, to a plate 105c provided with a central hole for the passage of the stem 103. In this way, inside the bellow 105 a volume 107 is defined, wherein the end portion of the stem 103 is housed, which stem is thus kept hermetically separated from the process fluid flowing through the valve 101.

The stuffing seal 1 comprises a case 3 provided with an axial hole 3a for the passage of the stem 103, a gasket or packing 5 arranged in a suitable seat 3b formed within said hole 3a between said case and said stem 103 and a stuffing box 7 for compressing said packing 5 between said case 3 and said stem 103. The packing 5 is formed of a series of overlapped metal, or preferably, polymeric resin rings 6. The stuffing box 7 is fixed to the case 3 by means of a pair of blocking pivots 9a, 9b, parallel to said stem 103, so that said stuffing box 7 and/or said case 3 can slide axially with respect to said pivots 9a, 9b.

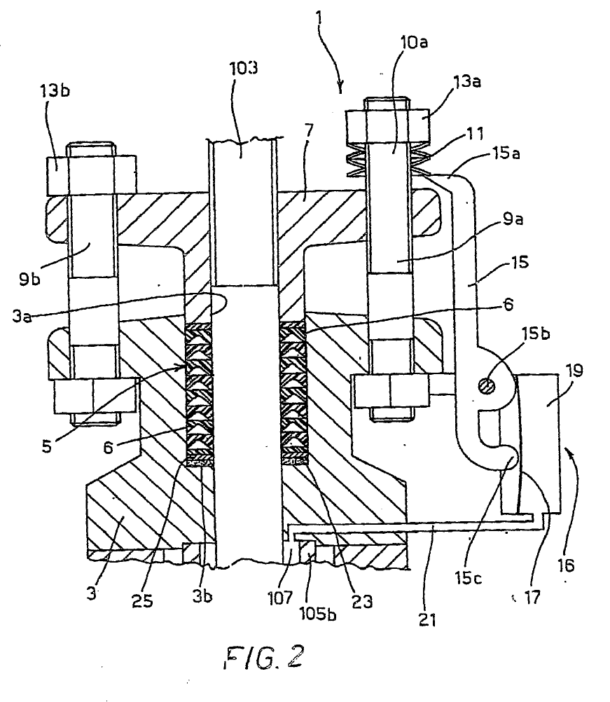

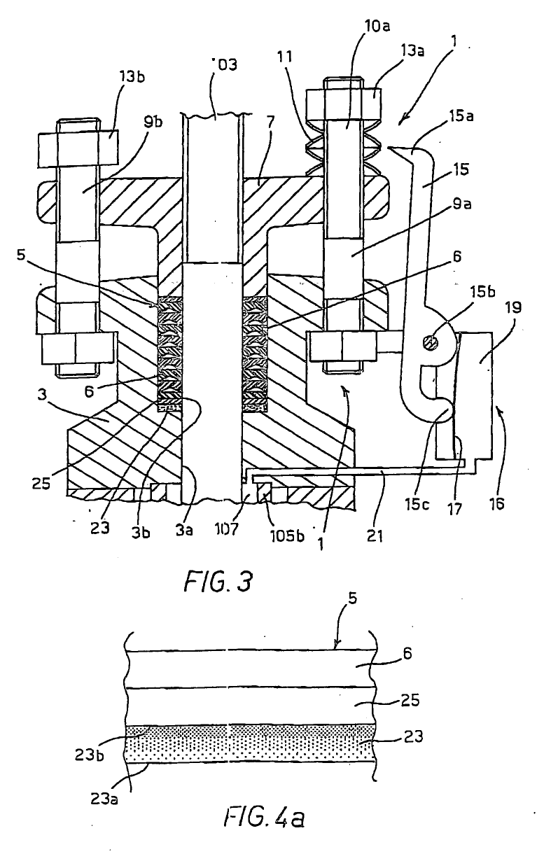

As it can be better seen in FIGS. 2 and 3, the stuffing seal 1 also provides means that, by acting on the stuffing box 7, allow to axially compress the packing 5 between the case 3 and the stem 103, increasing the seal of said packing 5 on said stem 103. In the preferred embodiment said means are made of a cup-like spring 11 mounted on the stem portion 10a of one of said blocking pivots 9a, which extends axially with respect to said stuffing box 7.

It is to be noted, however, that under normal operating conditions, to which FIG. 2 relates, i.e. when the seal on the stem 103 is ensured by the primary seal 105, said spring 11 is kept separated from the stuffing box 7 and it is compressed against the nut 13a of the pivot 9a by a blocking tooth 15a placed at the end of a lever 15 of first kind pivoted in 15a to a radial protrusion of the case 3. Under the above conditions, the packing 5 is not submitted to axial compression by the spring 11.

If the packing 5 is to be compressed, it is enough to act on the end 15c of the lever 15 opposed to the tooth 15a, approaching it to the case 3. In this way the rotation of the lever 15 around the fulcrum 15b leads the tooth 15a to radially depart in order to release the spring 11 and to allow it to extend up to the stuffing box 7 and, by acting thereon, to cause the axial compression of the packing 5. The above configuration is shown in FIG. 3.

It is evident that the releasable means for compressing the packing 5, instead of the cup-like spring 11, can be made of any element able, if released, to perform a compression on the stuffing box 7 (e.g. an helical spring or piston sliding along the stem of pivot 9a).

It is also evident that the lever 15 can be substituted by any mobile element provided with a blocking tooth which can be made to pass from a position wherein said tooth retains said releasable means to a position wherein it releases said releasable means.

Since in the embodiment shown the stuffing seal 1 functions as auxiliary seal, it is preferable that the packing 5 is compressed only in case of breakage of the primary seal, i.e. in case of fluid leak and seeping, of said fluid along the stem 103.

Therefore, it is convenient that the lever-15 is not manually driven by an operator to release the spring 11 (operation anyway always possible), but that it is automatically driven by an actuator in case of fluid leak through the primary seal.

In FIGS. 2 and 3 said actuator is a component of an leak detector 16 and it is made of a flexible membrane 17 placed inside the chamber 19 of said detector wherein the fluid coming from a leak through the primary bellow seal 105 can flow.

Said chamber 19 is connected with the volume 107 inside the bellow seal 105 through a channel 21. The flexible membrane 17 is constrained to the walls of the chamber 19, in order to hermetically separate said chamber from the external environment, and it has the face opposite to the chamber 19 facing the end 15c adjacent to the lever 15.

The configuration taken by said membrane 17 inside the chamber 19 depends on the ratio between the pressure inside and outside the chamber 19.

With reference to FIGS. 2 and 3, in case of fluid entering into the chamber 19, and of subsequent increase of the pressure inside said chamber, the membrane 17 takes a convex configuration with the convexity facing the surface 15b of the lever 15, thus causing the release of the spring 11 by the tooth 15a of said lever 15.

It is to be noted that, in case of multilayer bellow seals 105, the chamber 19 will be connected to the gap between two layers of said multilayer bellow seal 105, said gap being generally kept in depression. Since with the bellow seal 105 being intact also said chamber 19 is kept in depression, under these conditions the membrane 17 will keep a convex configuration with the convexity facing the chamber 19 (FIG. 2), passing to a configuration with the convexity facing the outside of sad chamber 19 (FIG. 3), only in case of fluid leaks through the layers of the bellow seal 105 towards the chamber 19.

However, in several applications, it can be advantageous to connect said chamber 19 directly to the volume 107 comprised between the stem 103 and the bellow seal 105. First of all, this solution can be implemented also in plants wherein one-layer bellow seals are used, i.e. in less sophisticated and more economic plants. This solution would make thus possible the use of a prompt and reliable leak detecting system also in a wide number of plants, also where a detecting system thus made is not required by regulations.

A solution of this kind also allows to incorporate the above leak detecting system in valves being already installed and operating.

Moreover, also in case of plants with valves using multilayer bellow seals, it can be convenient to connect the leak detector directly to said volume 107. In this way said detector signals a leak only in case of complete breakage of the bellow seal 105 and of effective seeping of fluid along the stem 103, i.e. of effective risk of contamination of the external environment.

In this latter type of valves it is also possible to realise a redundant leak detecting system with a first detector being connected to the gap between the layers of the bellow seal which promptly detects a partial breakage of said seal, and a second detector connected to the volume comprised between said bellow seal and the stem which detects a subsequent complete breakage of the seal.

In substitution of the flexible membrane 17, it will be possible, for example, to use a piezoelectric pressure detector connected to an electric circuit comprising an electromechanical actuator for said lever 15. Said actuator will also be controlled by the variation of different magnitude such as for example fluid temperature or chemical composition thereof.

Always with reference to FIGS. 2 and 3 between the seat bottom 3b and the packing 5 a porous metal ring 23 and a plane washer 25 are interposed in sequence.

In case of breakage of the primary seal 105, the process fluid seeps along the stem 103, till it meets the porous ring 23. Thanks to the porosity of said ring 23, the fluid diffuses inside its volume performing a substantially uniform compression against the washer 25.

As it can be better seen in FIG. 4a said ring 23 will advantageously be realised in any material compatible with the process fluid, in particular from the point of view of the resistance to corrosion. Said porous ring 23 will be obtained by overlapping sintered metal net layers, by using metal alloys resistant to corrosion (stainless steel, Monel, Inconel, etc.)

Advantageously, the porosity of said ring 23 will be chosen according to the density and viscosity of the process flow. In particular, by using sintered metal net overlapped layers, nets with different meshes will be used, the meshes being less thick in proximity of the face 23a of the ring 23 and then thicker and thicker while approaching the opposite face 23b of said ring.

The plane washer 25 is preferably a metal washer, realised with a metal or a metal alloy resistant to corrosion.

Said washer 25 and said porous ring 23 generally have the same diameter as the rings 6 forming the packing 5, but it will be also possible to realise a porous ring 23 with superior diameter with respect to that of said washer 25 and of said rings 6.

In order to interpose a further barrier between the process fluid and the packing 5, it is possible to insert, between the plane washer 25 and said packing 5 a flexible annular membrane, welded or glued along the external edge of the wall of the seat 3b of the packing 5.

Said membrane allows to avoid seepings along the wall of said seat 3b without interfering, thanks to its flexibility, with the axial thrust of the washer 25 on the rings of the packing 5.

The presence of said membrane is particularly advantageous in the case wherein the plane washer 25 has inferior diameter with respect to the porous ring 23.

According to a variation, shown in FIG. 4b, by using a material with suitable characteristics (i.e. with good mechanical and corrosion resistance properties) it is also possible to realise the porous ring 23 and the washer 25 in a single hybrid ring 27, with a layered configuration, i.e. with a first porous axial portion 27a and a second full axial portion 27b.

The pressure of the fluid escaping on said porous metal ring 23 and said plane washer 25 is enough to axially compress the packing 5 increasing the seal thereof on the stem 103. As a consequence thereof, a pressure raise in the volume 107 and in the chamber 19 occurs causing the change of configuration of the membrane 17 and the subsequent release of the spring 11 against the stuffing box 7.

In order to obtain a light constant compression on the packing 5 it will be also possible to lightly tighten the nut 13b of the blocking pivot 9b whereon the spring 11 is not provided. Advantageously, this compression does not considerably influence the wear of the packing and the leaks caused because of friction against the stem 103.

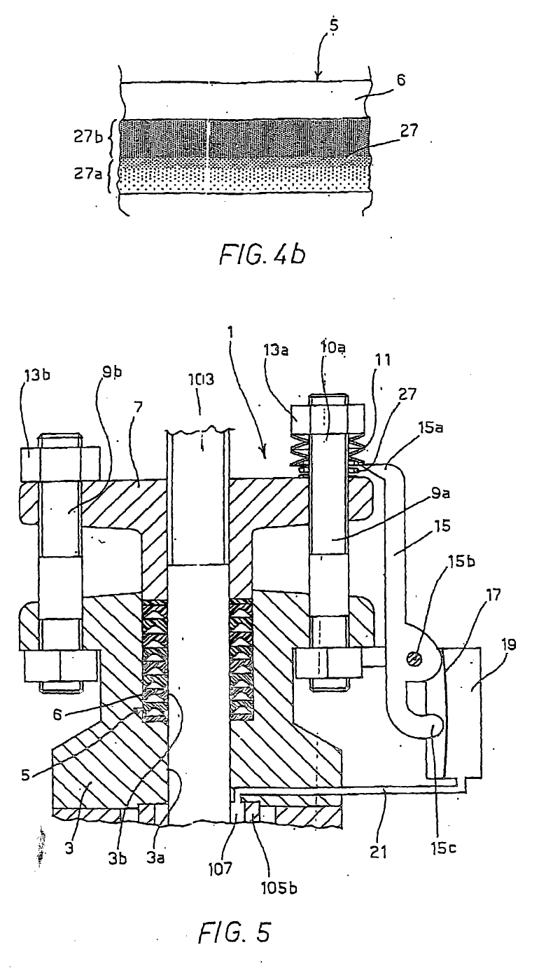

With reference to FIG. 5 a varying embodiment is shown wherein a second spring 27 is provided being interposed between said tooth 15a and the stuffing box 7. Said spring 27 constantly acts on the stuffing box 7, producing a light and constant axial compression on the packing 5.

In case of release of the tooth 15a and consequent release of the spring 11, said second spring 27 expands releasing the stuffing box 7, but it will be contrasted by said spring 11 which, being provided with higher potential elastic energy, will bring said second spring 27 back against said stuffing box 7 compressing the packing 5.

It is evident that what has been described is given only by way of non limiting example and that variations and changes are possible, within the scope of protection of the invention.

1. A stuffing seal comprising:
a case provided with an axial hole for the passage of a stem being mobile with respect to the case,
a gasket or packing arranged in a seat formed within said the hole between the case and the stem; and
a stuffing box for compressing the packing between said the case and the stem;
wherein it further comprises releasable means for performing an axial thrust on the stuffing box so as to cause a compression of the packing between the case and the stem.

2. The stuffing seal of claim 1, wherein the case and the stuffing box are interconnected by at least a blocking pivot parallel to the stem, the stuffing box and/or the case being sliding with respect to the pivot for allowing the axial compression of the packing.

3. The stuffing seal of claim 2, wherein the pivot comprises a portion axially extending outside the stuffing box, on that portion being provided the releasable means.

4. The stuffing seal of claim 1, wherein control means are provided for causing the release of the releasable means.

5. The stuffing seal of claim 1, wherein the releasable means comprise at least on elastically deformed element and control means for causing the release thereof.

6. The stuffing seal of claim 5, wherein the elastically deformed element is a spring.

7. The stuffing seal of claim 4, wherein the control means comprise a mobile element able to take a first position wherein the releasable means are retained and a second position wherein the releasable means are released for performing a thrust along the axis of the stem against the stuffing box.

8. The stuffing seal of claim 7, wherein the mobile element is an oscillating lever with the fulcrum pivoted to the case, the lever comprising at one end a blocking tooth for retaining the releasable means.

9. The stuffing seal of claim 8, wherein the lever is a lever of the first kind comprising, at the opposite end with respect to the tooth, a control surface whereon it is possible to act for letting the lever pass from the first to the second position.

10. The stuffing seal according to any of claim 7, wherein the mobile element is driven by means of an actuator device, in turn driven by a leak detector.

11. The stuffing seal of claim 10, wherein the leak detector comprises a chamber, wherein the fluid coming from a leak flows.

12. The stuffing seal of claim 11, wherein the actuator device is a flexible membrane which hermetically separates at least one portion of the chamber from the an external environment.

13. The stuffing seal of claim 8, wherein means for permanently partially compressing the packing in an axial direction are further provided.

14. The stuffing seal of claim 13, wherein the thrust performed on the packing by the compression means is considerably lower than the thrust performed by the releasable means.

15. The stuffing seal of claim 13, wherein the compression means comprise a spring interposed between the stuffing box and the tooth of the lever.

16. The stuffing seal of claim 13, wherein the compression means comprise a blocking pivot parallel to the stem placed between the case and the stuffing box, provided with a nut which can be closed against the case or against the stuffing box for causing the axial compression of the packing.

17. The stuffing seal according to any of the of claim 1, wherein, between the bottom of the seat within the hole and the packing, a porous ring and a plane washer are further provided in sequence thanks to which the packing is axially compressed against the stuffing box when the pressure of a fluid acts against the porous.

18. The stuffing seal of claim 17, wherein the porous ring is a sintered metal net ring.

19. The stuffing seal of claim 1, wherein the packing comprises a series of concentric rings preferably made of metal or polymeric resin.

20. A valve for fluids comprising:
a stem for controlling the opening and the closing of the valve,
a primary seal which maintains hermetically separated from an external environment the fluid flowing through the valve,
an auxiliary seal able to intervene for maintaining hermetically separated from the external environment the fluid flowing through the valve in case of breakage or misoperation of the primary seal,
wherein the auxiliary seal is a stuffing seal is a stuffing seal in turn comprising:
a case provided with an axial hole for the passage of a stem being mobile with respect to the case;
a gasket or packing arranged in a seat formed within the hole between the case and the stem;
a stuffing box for compressing the packing between the case and the stem, and
releasable means for performing an axial thrust on the stuffing box so as to cause a compression of the packing between the case and the stem.

21. The valve for fluids of claim 20, wherein the primary seal further comprises a bellow seal and a leak detector, the leak detector in turn comprising a chamber, wherein the fluid flows in case of leak, connected through a channel to a volume inside the bellow seal.

22. The valve for fluids of claim 20, wherein the primary seal further comprises a multilayer bellow seal and a leak detector, the leak detector in turn comprising a chamber, wherein the fluid flows in case of leak, connected through a channel to a gap defined between two layers of the multilayer bellow seal.

23. The valve for fluids of claim 20, wherein the stuffing seal further comprises control means for causing the release of the releasable means.

24. The valve for fluids of claim 20, wherein the releasable means of the stuffing seal comprise at least one elastically deformed element and control means for causing the release thereof.

25. The valve for fluids of claim 24, wherein the elastically deformed element is a spring.

26. The valve for fluids of claim 23, wherein the control means of the stuffing seal comprise a mobile element able to take a first position wherein the releasable means are retained and a second position wherein the releasable means are released for performing a thrust along the axis of the stem against the stuffing box.

27. The valve for fluids of claim 26, wherein the mobile element is an oscillating lever with the fulcrum pivoted to the case, the lever comprising at one end a blocking tooth for retaining the releasable means.

28. The valve for fluids of claim 27, wherein the lever is a lever of the first kind comprising, at the opposite end with respect to the tooth, a control surface whereon it is possible to act for letting the lever pass from the first to the second position.

29. The valve for fluids of claim 26, wherein the mobile element is driven by means of an actuator device, in turn driven by a leak detector.

30. The valve for fluids of claim 29, wherein the leak detector comprises a chamber, wherein the fluid coming from a leak flows.

31. The valve for fluids of claim 30, wherein the actuator device is a flexible membrane which hermetically separates at least one portion of the chamber from an external environment.

32. The valve for fluids of claim 27, wherein means for permanently partially compressing the packing in an axial direction are further provided.

33. The valve for fluids of claim 32, wherein the thrust performed on the packing by the compression means is considerably lower than the thrust performed by the releasable means.

34. The valve for fluids of claim 32, wherein the compression means comprise a spring interposed between the stuffing box and the tooth of the lever.

35. The valve for fluids of claim 32, wherein the compression means comprise a blocking pivot parallel to the stem placed between the case and the stuffing box, provided with a nut which can be closed against the case or against the stuffing box for causing the axial compression of the packing.

36. The valve for fluids of claim 20, wherein, between the bottom of the seat within the hold and the packing of the stuffing seal, a porous ring and a plane washer are further provided in sequence thanks to which the packing is axially compressed against the stuffing box when the pressure of a fluid acts against the porous ring.

37. The valve for fluids of claim 36, wherein the porous ring is a sintered metal net ring.

38. The valve for fluids of claim 20, wherein the packing of the stuffing seal comprises a series of concentric rings preferably made of metal or polymeric resin.

39. The valve for fluids of claim 20, wherein the case and the stuffing box of the stuffing seal are interconnected by at least a blocking pivot parallel to the stem, the stuffing box and/or the case being sliding with respect to the pivot for allowing the axial compression of the packing.

40. The valve for fluids of claim 21, wherein the pivot comprises a portion axially extending outside the stuffing box, on that portion being provided the releasable means.
